(19) United States
(12) Patent Application Publication
(10) Pub. No.: US 2018/0077463 A1
(43) Pub. Date: Mar. 15, 2018

(54) INTERACTIVE MOVIE SYSTEM AND METHOD FOR USING

(71) Applicant: Damon Merchant, Southfield, MI (US)

(72) Inventor: Damon Merchant, Southfield, MI (US)

(21) Appl. No.: 15/698,864

(22) Filed: Sep. 8, 2017

Related U.S. Application Data
(60) Provisional application No. 62/385,285, filed on Sep. 9, 2016.

(51) Int. Cl. H04N 21/475; H04N 21/433; H04N 21/41; H04N 21/482

(52) U.S. Cl. CPC H04N 21/4758; H04N 21/433; H04N 21/482; H04N 21/4122; H04N 21/4126

(57) ABSTRACT

An interactive movie system for enabling viewer interaction with a movie, the interactive movie system comprising: (a) a storage unit for storing a plurality of movie segments; (b) a projector for displaying the plurality of movie segments, one after the other, the projector being in communication with the storage unit; (c) a network service for receiving votes from a plurality of viewer-associated mobile devices, the network service including filtering means for accepting votes cast from at least one predetermined group of mobile devices comprising at least a portion of the plurality of mobile devices; and (d) a tabulating system for calculating a decision based on a plurality of votes cast by at least one predetermined group of mobile devices.

This application is a completion application which claims the priority benefit of co-pending U.S. Provisional Patent Application Serial No. 62/385,285, filed Sep. 9, 2016, for “Interactive Movie System and Method for Using,” the disclosure of which is hereby incorporated by reference in its entirety, including the drawing.

### BACKGROUND OF THE INVENTION

### 1. Field of the Invention

The present invention pertains to a movie system and method for using same. More particularly, the present invention concerns interactive movie systems. Even more particularly, the present invention pertains to an audience's interaction with the movie system during viewing.

### 2. Description of Related Art

With the improvements in movie production technology over the decades, films have begun to adapt new and exciting ways to promote audience involvement and interaction during a movie presentation.

Such interaction by the viewers includes the ability to play a role in determining the decisions certain characters make in the movie, thus dramatically altering the storyline of the movie and even the overall conclusion. This concept of audience involvement in order to deviate from a single storyline is commonly referred to as “gamebooks” and was made popular in the early 1940s. In 1941, Argentinian author Jorge Luis Borges published a book titled “Examen de la obra de Herbert Quain,” which featured a three-part story containing two branch points and a total of nine possible endings stemming from the possible decisions that can be made at the two branch points.

Gamebooks were also commonly used for educational purposes allowing students to learn a subject without the use of a teacher. At each branch point, the student would answer a multiple-choice question. If the student provided the correct answer, they would be directed to a page with a further question. Alternatively, if the student provided an incorrect answer, the student would be directed to a page containing an explanation as to why that answer was incorrect.

The concept of gamebooks or branching-path books became even more popular in the early 1980s by the “Choose Your Own Adventure” series published by Bantam Books. In the series, the reader assumes the role of the protagonist and makes choices that determine the main character's actions and the plot outcome.

With the “Choose Your Own Adventure” series becoming such a hit, the concept migrated from strictly literary works to becoming incorporated into audiovisual works as well. A number of prior art references are disclosed below that specifically employ this concept of audience interaction in either a personal movie viewing setting or a movie theater environment.

U.S. Pat. No. 4,591,248 to Freeman discloses a movie changeover system which provides a movie presentation having alternative movie display content depending on the viewing audience's responses to choices presented during the course of the movie presentation. The movie changeover system utilizes a pair of projectors connected to a changeover shutter mechanism that controls which projector is utilized at any given time during the movie presentation. Each projector contains a reel that projects a different portion or version of the overall movie. Based on the responses from the audience at a number of decision points, the changeover shutter mechanism controls which reel is projected in order to play an associated scene or version of the movie. Thus, the movie changeover system disclosed in Freeman requires at least a pair of projectors or, alternatively, quick and efficient swapping of reels in order to prepare each of the possible choices prior to each decision point.

U.S. Pat. No. 9,237,297 to Waddell et al. teaches a digital film entertainment system including computer hardware, software, on-line content, and audio/video media that allows a viewer to watch a story unfold in a nonlinear fashion according to the desires of the viewer. The system provides a story broken up into multiple story segments corresponding to each character's vantage points. While the viewer can choose to watch the movie from only a single character's vantage point, the viewer may also choose to jump between movie segments and timelines as desired in order to view the movie from an alternative character's perspective. While this provides an avenue for the viewer to move between multiple character's viewpoints, it fails to allow the viewer to make decisions as to a character's actions.

U.S. Pat. No. 5,645,384 to Bejan et al. teaches an interactive entertainment system that allows an audience to select both the perspective and plot of an interactive movie. Each audience member is provided with a polling unit with which he or she uses to vote at the conclusion of certain scenes of the movie. A polling computer and main computer tabulate the results and select the next scene in the movie to be displayed based on the more popular decision voted on by the audience. The process continues until the end of the movie with the audience making continual decisions throughout. The system disclosed herein fails to allow the audience members to utilize their own personal electronic devices in order to vote and, thereby, they are limited to casting their votes on the provided polling units.

U.S. Pat. No. 8,789,082 to Rakoff et al. teaches a method and apparatus for providing immediate audience interaction and participation with a movie while the movie is being shown to an audience, either in a public theater or at home. Audience members in a theater are able to respond to prompts on a handheld communication device and vote on upcoming scene selections corresponding to a character's decision in the movie. After tallying the votes by the audience members, the most popular scene selection is displayed, thus providing a movie with alternative paths and endings.

While the methods and systems disclosed above allow for mass audience voting via polling units, their own personal electronic device, or the like, the various aspects of audience interaction during the movie is limited to merely viewing alternative character's viewpoints and determining character decisions.

Additionally, while each of the systems and methods disclosed in the above references are suitable for the uses and problems they intend to solve, there is an ongoing need for improvements in interactive movie systems and methods for using same, such as including allowing the viewers to have more of an impact on the decision by pitting the viewers against each other and turning the movie viewing presentation into a fully interactive experience.

It is to this to which the present invention is directed.

These above references are identified herein in recognition of a duty of disclosure of related subject matter, which may be relevant under 37 CFR 1.56, and specifically incorporated, herein by reference as regards the conventional approaches and constructions taught therein.

### SUMMARY OF THE INVENTION

The present invention provides, in a first aspect, an interactive movie system for enabling viewer interaction with a movie, the interactive movie system comprising: (a) a storage unit for storing a plurality of movie segments; (b) a projector for displaying the plurality of movie segments, one after the other, the projector being in communication with the storage unit; (c) a network service for receiving votes from a plurality of viewer-associated mobile devices, the network service including filtering means for accepting votes cast from at least one predetermined group of mobile devices comprising at least a portion of the plurality of mobile devices; and (d) a tabulating system for calculating a decision based on a plurality of votes cast by at least one predetermined group of mobile devices.

The present invention provides, in a second aspect, a method for enabling viewer interaction with a movie, the method comprising: (a) categorizing a plurality of viewer-associated mobile devices into at least one group; (b) displaying a first movie segment via a projector; (c) displaying a prompt associated with the first movie segment via the projector at the conclusion of the first movie segment; (d) displaying the prompt on a network service at the conclusion of the first movie segment, the network service capable of being accessed by the plurality of mobile devices; (e) receiving votes cast from the at least one group; (f) tabulating the votes received via a tabulating system to calculate a decision; (g) retrieving a second movie segment from a storage unit, the second movie segment corresponding to the decision calculated by the tabulating system; and (h) displaying the second movie segment via the projector.

For a better understanding of the present invention, reference is made to the accompanying drawing and detailed description. In the drawing, like reference numerals refer to like parts through the several views, in which:

### BRIEF DESCRIPTION OF THE DRAWING

FIG. 1 is a block diagram of an interactive movie system for enabling viewers to interact with a movie;

FIG. 2 is a block diagram of the interactive movie system wherein votes are cast via a plurality of viewer-associated mobile devices;

FIG. 3 is an example of a prompt being displayed on a mobile device requiring a vote to be cast;

FIG. 4 is a flowchart of a method for enabling viewer interaction with a movie from the perspective of the interactive movie system;

FIG. 5 is a flowchart of the method from the perspective of a viewer; and

FIG. 6 is a flowchart of the method depicting the alternative possibilities of movie segments each corresponding to a different potential decision calculated for each prompt.

### DETAILED DESCRIPTION OF THE INVENTION

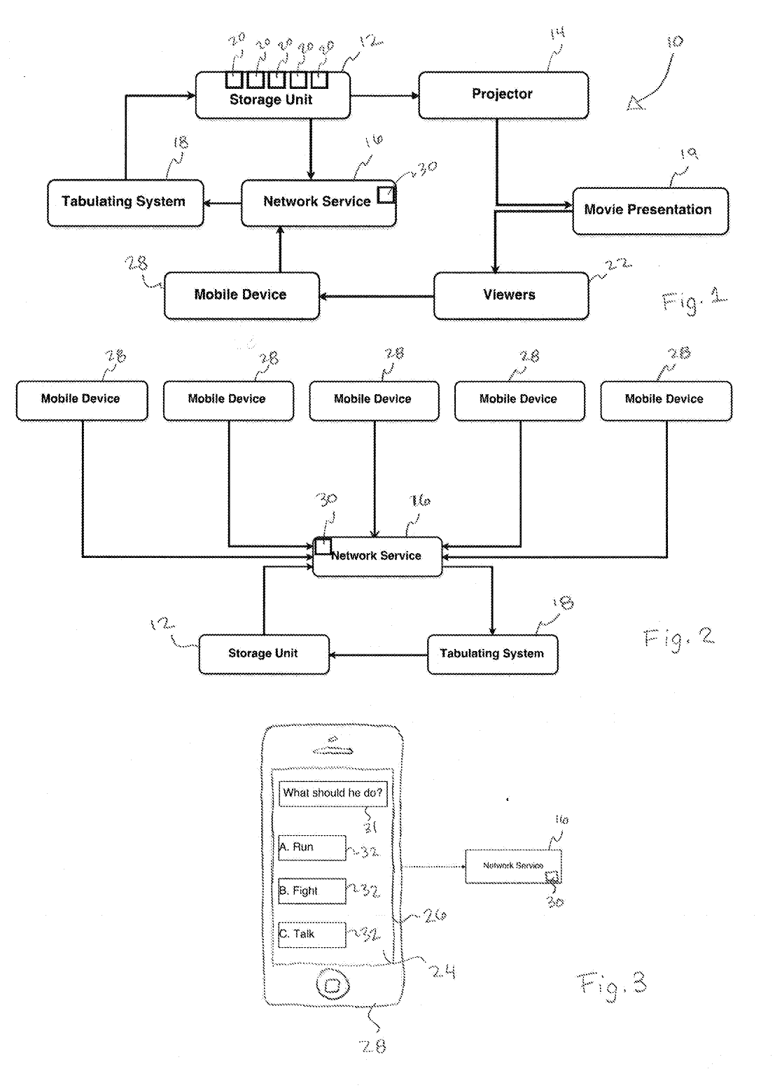

Now, and in accordance with the present invention and with reference to FIGS. 1-3 of the drawing, there is provided, in a first aspect, an interactive movie system for enabling viewer interaction with a movie, generally denoted at 10, comprising: (a) a storage unit 12; (d) a projector 14 in communication with the storage unit 12; (c) a network service 16; and (d) a tabulating system 18.

While the terms “film,” “movie,” or “movie presentation” used throughout may reference any type of audio visual presentation, such as that viewed on a home video, online video or the like, it is desired and preferable that the present invention described herein is utilized in particular with a movie or film viewed by a live audience in a theater-like setting.

As shown in the drawing, the storage unit 12 of the present invention stores a plurality of distinct and separate movie segments 20 to be displayed by the projector 14 and viewed by a plurality of viewers 22 in an audience. Each of the movie segments 20 comprises portions and alternative versions of an overall movie presentation 19 to be displayed on a projector screen. Each movie segment 20 ranges in length and size based on the specific scene of the movie. Therefore, the storage unit 12 contains enough storage space capable of storing the plurality of movie segments 20 and other data files potentially exceeding 1 Terabyte. The storage unit 12 itself may be any suitable storage medium such as an internal or external RAM or DRAM storage device capable of storing and playing mass amounts of video files in various video formats including, but not limited to, MKV, VOB, AVI, MOV, WMV, MP4, MPG, and MPEG. The plurality of movie segments 20 is preferably stored as a single video format, but may range in formats based on the size, frame rate, and quality of the specific movie segment.

In larger movie theaters, a centrally located theater management system is utilized to communicate with a plurality of projectors and determine which movie files to play on which projectors at a certain time. Here, the present invention may be adapted to this configuration such that the theater management system operates as the storage unit 12 by sending the appropriate movie segments 20 to an associated projector 14 when required. Where the storage unit 12 is centrally located away from the projector 14, communication between the two may be established via an internet connection such as HTTP, HTTPS, API, or the like.

Each of the plurality of movie segments 20 either contains or is linked to an associated prompt 24 that is displayed at the conclusion of the movie segment 20 via the projector 14 and the network service 16 as described below.

The storage unit 12 is in communication with the projector 14 in order to display the plurality of movie segments 20. Preferably, as noted above, the present invention is employed in a mass viewing audience environment such as a movie theater. Therefore, preferably a high quality DLP projector is preferably used to provide optimal high-definition viewing on a large projector screen. Alternatively, an LCD or LED projector may be used where the movie is shown to a smaller audience on a smaller projector screen. Also, the projector 14 is connected to the storage unit 12 via an HDMI or similar audio/video transmission cable in order to provide the highest quality and seamlessly stream video from the storage unit 12. Alternatively, the projector 14 may be connected to the storage unit 12 wirelessly via Bluetooth, Wi-Fi, wireless HDMI transmitters, or the like.

It is also to be understood that predetermined advertisements may be readily overlaid onto any of the prompts 24 for marketing purposes. Advertisements may be submitted via the network service 16, discussed below, or manually added to a prompt 24 in the storage unit 12 via an input device (not shown). In either manner, the advertisement may be displayed within the movie presentation 19 itself via the projector 14 or on the network service 16 which the viewers 22 access during voting. Preferably, any advertisement displayed is related to some detail of the movie segment 20 just viewed for purposes of product placement.

The network service 16 is employed in order to determine the order by which the movie segments 20 stored within the storage unit 12 are displayed via the projector 14. The network service 16 is an online platform that provides a user interface for viewers 22 to cast their votes for the prompt 24 currently being displayed. The network service 16 is either a cloud-based service or a website. Preferably, the viewers 22 download an application 26 on a viewer-associated mobile device 28 that either redirects the viewers 22 to the website automatically or, alternatively, operates as a fully functional software application 26 that sends and receives signals between the application 26 and the network service 16. In either instance, at the conclusion of the movie segment 20, the prompt 24 associated with the just concluded movie segment 20 is displayed via the projector 14 and on the mobile device 28 via the network service 16. The viewers 22 then access the network service 16 via the application 26 downloaded on their mobile device 28 to cast their vote as discussed below. Where a website is utilized, the website either continually refreshes to display the appropriate prompt 24 in the body of the website. Alternatively, each prompt 24 is provided on a separate website which the viewers 22 are redirected to within the application 26, thereby avoiding the need to modify an existing website with each new prompt 24.

The network service 16 of the present invention further includes filtering means 30 for dividing the plurality of viewers 22 into “groups” associated with a specific character, storyline, or the like. The filtering means 30 appears as an initial screen on the application 26 and requires the plurality of viewers 22 to select a group via their mobile device 28. Once the viewers 22 select a group, the filtering means 30 limits access to the prompt 24 on the network service 16 such that the viewers 22 are only permitted to vote on specific prompts relevant to their chosen group. Thereafter, the network service 16 only accepts votes from viewers 22 within a permitted group for that specific prompt. Each prompt 24 sent to the network service 16 contains metadata as to which group or groups are permitted to vote on that specific prompt. In some cases, all groups are permitted access to the prompt, yet, in other cases, only one group might be permitted access to the prompt. This concept of selective group voting adds a competitive element to the movie presentation 19 and increases the viewers' 22 motives by way of strategic voting.

Each of the prompts 24 are either sent to the network service 16 directly from the storage device 12 via an internet connection or the like at the conclusion of an associated movie segment 20 or, alternatively, the prompts 24 are stored within an online database of the network service 16 and displayed when the associated movie segment 20 ends. In either instance, the conclusion of the movie segment 20 creates a trigger point which effectuates the prompt 24 being sent to the network service 16 or the network service 16 retrieving the prompt 24 from the online database to be displayed.

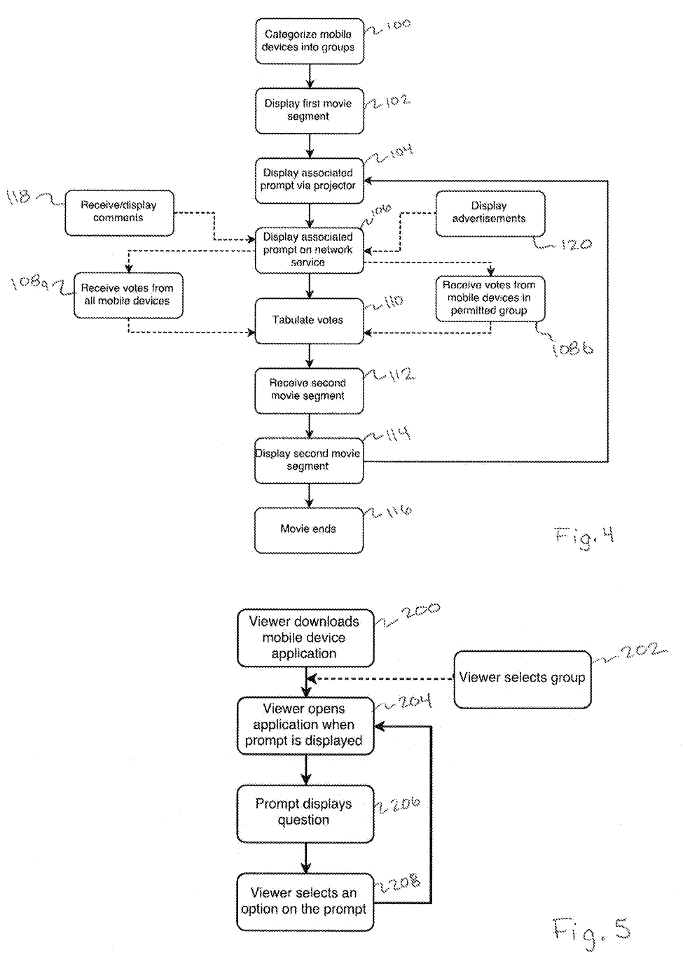

As shown in FIG. 3, an example of a prompt 24 is displayed on an application 26, which has been downloaded on a viewer's mobile device 28. Here, the prompt 24 displays a question 31 with a plurality of options 32 based on the movie segment 20 just watched. The plurality of options 32 depict potential decisions a specific character in the movie might make or event that might occur. In the case of a suspense film where the character is in danger, an example of such a prompt 24 may display a question 31 asking “What should he do?” and provide a plurality of options 32 such as: “A. Run;” “B. Fight;” or “C. Talk.”

The votes cast by the viewers 22 determine which movie segment 20 will be played next. Therefore, each movie segment 20 within the storage unit 12 corresponds to a specific option 32 of the previously displayed prompt 24. For example, Options A, B, and C in the prompt 24 each correspond to a different movie segment 20 illustrating the outcome of that option 32. Codes, hyperlinks, reference numbers, or some other indicia may be used in order to correlate each option 32 to a corresponding movie segment 20.

Voting is only open on the network service 16 for a predetermined amount of time in order to ensure that there is not a significant delay between movie segments 20. After voting has closed, where all viewers 22 have casted their votes or time runs out, a signal is sent to the tabulating system 18 for determining the more popular option of those options 32 provided in the prompt 24.

The more popular option among those voted on by the viewers 22 is determined by running each of the votes cast through the tabulating system 18 which then calculates a “decision.” Based on which option 32 of the prompt 24 is determined to be the decision, a signal is sent from the tabulating system 18 to the storage unit designating the next associated movie segment 20 to be displayed via the projector 14.

The storage unit 12 and tabulating system 18 may be components of a single computing device. Where a computing device is used, the computing device further includes common operating components, although not shown, such as a display screen, keyboard, mouse, and the like.

Alternatively, the tabulating system 18 may be integrally formed within the network service 16 or a separate cloud-based or online service. Here, the tabulating system 18 is built into the same online service as the network service 16. Therefore, the accumulation of votes and decision calculation takes place entirely within the network service 18, which then sends a signal to the storage unit 12 once the decision to the prompt 24 is calculated in order to retrieve the next corresponding movie segment 20.

Further functionality of the network service 16 and tabulating system 18 is contemplated, such as permitting the viewers 22 to select a song or style of music to be played, during voting. This music selection is determined in the same manner as described above in calculating the decision after voting on a prompt 24. Here, viewers are provided with an additional prompt 24, not necessarily related to the movie segment 20 being viewed, to enable the viewers 22 to vote on music to be played at a later time, either during the movie presentation 19 or during the following prompt 24.

Additionally, the network service 16 is capable of receiving text inputs, such as comments from viewers, from the mobile devices 28 either during the movie presentation 19 or voting in order to sway votes from other viewers 22 in their favor. This adds an element of persuasion to the viewing experience in order to manipulate the outcome of the movie presentation 19. When comments are received by the viewers 22, the network service 16 sends each of the comments to the storage device 12, which converts the comment into a viewable medium to be displayed via the projector. Where necessary, approval of each of the comments may be required.

The interactive movie system 10 continues to play movie segments 20 and calculate decisions until a final movie segment 20 is reached that does not contain a prompt 24. This final movie segment 20 concludes the movie presentation 19 and, preferably, the credits begin to roll or other indicia demonstrating the end of the movie presentation 19.

A second aspect of the present invention provides a method for enabling viewer interaction with a movie by utilizing the above interactive movie system 10. As shown in FIGS. 4-6, an exemplary embodiment of the present invention is illustrated.

FIG. 4 illustrates the method for determining the selection of movie segments based on receiving and tabulating viewer voting from the perspective of the above interactive movie system 10 in accordance herewith.

Initially, a plurality of viewer-associated mobile devices is categorized into at least one group 100. Thereafter, a first movie segment is displayed at 102 via a projector. At the conclusion of the first movie segment, a prompt associated with the first movie segment is projected at 104. The prompt is then sent to a network service at 106 to be accessed by either all mobile devices or at least one group of mobile devices categorized at step 100. Where the viewers are not required to select a group, votes are received from all mobile devices at 108a. Alternatively, where the viewers are required to select a group, votes are received from only those permitted groups at 108b. Thereafter, a tabulating system receives the votes from the network system and tabulates the votes at 110 in order to determine the most popular option or “decision.” Based on the calculated decision, a second movie segment associated with that decision is received at 112 and displayed via the projector at 114. Steps 104-114 are repeated as necessary until a movie segment is displayed that does not include an associated prompt. Upon the movie segment concluding without a further prompt, the movie ends at 116, preferably by rolling credits or similar ending scene.

Further steps are provided that demonstrate additional functionality such as receiving and displaying comments at 118 and displaying advertising at 120. As noted above, the network service may receive comments and advertisements, upon approval, that are displayed via the projector, on the application for viewing on the mobile device, or both.

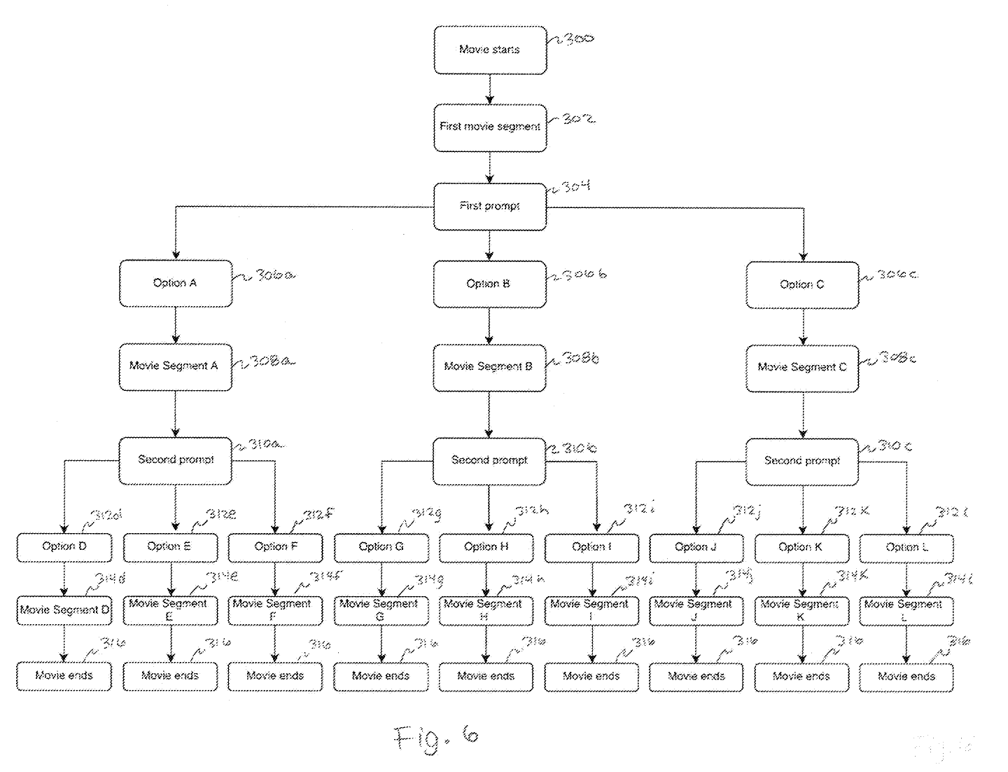

FIG. 5 illustrates the same method illustrated in FIG. 4 from the perspective of a viewer. Initially, prior to the start of a movie, a plurality of viewers download an application at 200 to their associated mobile devices which connects the viewers to the network service. When required, the viewers access the application and select a group at 202. By selecting a group, the viewers are limited to only voting on specific prompts relevant to their group. This group selection may occur either before the movie presentation begins or at some desired point during the movie presentation. Once a prompt is displayed via the projector, the viewers open the application at 204. The prompt displays a question at 206 based on a movie segment just watched and provides a number of options. If a viewer is a member of the permitted group, the viewer selects an option at 208 based on their opinion as to how the movie should continue. This viewer voting process continues when each prompt is displayed at the end of each movie segment by repeating steps 204-208.

FIG. 6 illustrates a flowchart depicting the numerous movie segments that are associated with each option of a prompt. As noted in the above interactive movie system 10, each movie segment is associated with an option or calculated decision. As shown in FIG. 6, the movie starts at 300 and a first movie segment is displayed at 302. At the conclusion of the first movie segment, a prompt is displayed at 304, which provides any number of option three possible options shown here are, Option A at 306a, Option B at 306b, and Option C at 306c, branching from the prompt that can be voted on by the viewers. Depending on which option is calculated to be the most popular option or “decision” among the viewers, the next corresponding movie segment is selected to be displayed. For example, Movie Segment A 308a corresponds to Option A 306a, Movie Segment B 308b corresponds to Option B 306b, and Movie Segment C 308c corresponds to Option C 306c. Thereafter, at the conclusion of either Movie Segment A 308a, Movie Segment B 308b, or Movie Segment C 308, whichever is determined to be the most popular option by the viewers, an associated second prompt 310a, 310b, 310c is displayed at the conclusion of that movie segment. The above process continues by displaying Options D-L 312d-312l and corresponding Movie Segments D-L 314d-314l based on the most popular option. The movie presentation ends at 316 when a movie segment is displayed that does not include an associated prompt.

From the above, it is to be appreciated that defined herein is a new and unique interactive movie system and method for using where a plurality of viewers, split into groups, vote on a plurality options in order to determine movie decisions and alter the overall storyline of a movie.

### LIST OF REFERENCE NUMBERS

10 Interactive movie system
12 Storage unit
14 Projector
16 Network service
18 Tabulating system
19 Movie presentation
20 Movie segment
22 Viewers
24 Prompt
26 Application
28 Mobile device
30 Filtering means
31 Question
32 Option
100 Categorize mobile devices
102 Display first movie segment
104 Display prompt via projector
106 Display prompt on network service
108a Receive votes from all mobile devices
108b Receive votes from mobile devices of permitted groups
110 Tabulate votes and calculate decision
112 Receive second movie segment
114 Display second movie segment
116 Movie ends
118 Receive/display comments
120 Display advertisements
200 Viewer downloads mobile device application
202 Viewer selects group
204 Viewer opens application when prompt is displayed
206 Prompt displays question
208 Viewer selects an option
300 Movie starts
302 First movie segment
304 First prompt
306a Option A
306b Option B
306c Option C
308a Movie Segment A
308b Movie Segment B
308c Movie Segment C
310a Second prompt
310b Second prompt
310c Second prompt
312d Option D
312e Option E
312f Option F
312g Option G
312h Option H
312i Option I
312j Option J
312k Option K
312l Option L
314d Movie Segment D
314e Movie Segment E
314f Movie Segment F
314g Movie Segment G
314h Movie Segment H
314i Movie Segment I
314j Movie Segment J
314k Movie Segment K
314l Movie Segment L
316 Movie ends

1. An interactive movie system for enabling viewer interaction with a movie, the interactive movie system comprising:
(a) a storage unit for storing a plurality of movie segments;
(b) a projector for displaying the plurality of movie segments, one after the other, the projector being in communication with the storage unit;
(c) a network service for receiving votes from a plurality of viewer-associated mobile devices, the network service including filtering means for accepting votes cast from at least one predetermined group of mobile devices comprising at least a portion of the plurality of mobile devices; and
(d) a tabulating system for calculating a decision based on a plurality of votes cast by the at least one predetermined group of mobile devices.

2. The interactive movie system of claim 1, wherein said storage unit further comprises means for communicating an image including a list of viewer choices at the end of at least one movie segment, the viewer using the mobile device to vote on at least one choice presented in the image.

3. The interactive movie system of claim 2, wherein the tabulating system communicates a signal to the storage unit regarding the choice and designates the next movie segment to be displayed via the projector.

4. The interactive movie system of claim 1, wherein at least one of the movie segments is associated with a prompt that is displayed at the conclusion of the movie segment via the projector and network service, the prompt being displayed on the mobile device and requiring a vote to be cast by the viewer.

5. The interactive movie system of claim 4, wherein the prompt is provided with a predetermined advertisement.

6. The interactive movie system of claim 2, wherein the filtering means requires a plurality of viewers to choose a group via their mobile device.

7. The interactive movie system of claim 6, wherein the filtering means limits access to the prompt such that viewers are only permitted to vote on specific prompts relative to their chosen group.

8. The interactive movie system of claim 4, wherein the prompt displays a question with a number of options for selection based on the just watched movie segment.

9. The interactive movie system of claim 8, wherein the options depict potential decisions a specific character in the movie might make or an event that might occur.

10. The interactive movie system of claim 8, wherein the option in each prompt corresponds to different movie segment and manipulates the outcome of the movie by selecting that option.

11. The interactive movie system of claim 2, wherein the votes cast are transmitted to the tabulating system which calculates a decision that represents the most popular option among those that voted to manipulate the outcome of the movie presentation, whereupon a signal is sent from the tabulating system to the storage unit designating the next associated movie segment to be displayed via the projector.

12. The interactive movie system of claim 1, wherein the projector is connected wirelessly to the storage system.

13. The interactive movie system of claim 1, further comprising means for enabling each of the mobile devices to access the network and thereby allow the viewer to access the movie segments and vote.

14. The interactive movie system of claim 1, wherein the network service is cloud based.

15. The interactive movie system of claim 1, wherein the network service is a website.

16. The interactive movie system of claim 1, wherein the mobile device includes an application that directs a viewer to the network service.

17. A method for enabling viewer interaction with a movie, the method comprising:
(a) categorizing a plurality of viewer-associated mobile devices into at least one group;
(b) displaying a first movie segment via a projector;
(c) displaying a prompt associated with the first movie segment via the projector at the conclusion of the first movie segment;
(d) displaying the prompt on a network service at the conclusion of the first movie segment, the network service capable of being accessed by the plurality of mobile devices;
(e) receiving votes cast from the at least one group;
(f) tabulating the votes received via a tabulating system to calculate a decision;
(g) retrieving a second movie segment from a storage unit, the second movie segment corresponding to the decision calculated by the tabulating system; and
(h) displaying the second movie segment via the projector.

18. The method of claim 17, the method further comprising storing on the network service an interactive movie including multiple movie segments with each segment followed by more than one prompt that leads to a different path of the movie wherein the viewer at the end of one segment votes for one of the prompts and the network service retrieves and displays the movie segment reflective of the vote by the viewers.

19. The method of claim 15, the method further comprising wirelessly connecting the projector to the network service system.

20. The method of claim 15, the method further comprising downloading an application on the mobile device that enables signals between the application and the network service to be sent and received, wherein at the conclusion of a movie segment the prompt associated with the movie segment just concluded is displayed via the projector and on the mobile device via the network service.

21. An interactive movie produced according to the method of claim 17.
